(19) United States
(12) Patent Application Publication
(10) Pub. No.: US 2015/0030136 A1
(43) Pub. Date: Jan. 29, 2015

(54) SPLIT CT GANTRY

(71) Applicant: General Electric Company, Schenectady, NY (US)

(72) Inventors: James Loren Dodge, Waukesha, WI (US); Chad Allan Smith, Waukesha, WI (US); Timothy Matthew Behlmer, Waukesha, WI (US)

(73) Assignee: General Electric Company, Schenectady, NY (US)

(21) Appl. No.: 13/950,981

(22) Filed: Jul. 25, 2013

(51) Int. Cl. H05G 1/02

(52) U.S. Cl. CPC H05G 1/02
USPC 378/204; 29/592.1

(57) ABSTRACT

A split gantry for a CT system includes a rotatable side comprising a configurable arrangement of image chain components of the CT system, a stationary side comprising a stationary support base and a gantry bearing, wherein the rotatable side is separate from the stationary side, and the stationary side is attachable to a rotatable portion of the gantry bearing without having to align the image chain components during an installation of the CT system.

### BACKGROUND

This disclosure relates generally to diagnostic imaging and, more particularly, to an improved support gantry for a computed tomography (CT) system.

Typically, in computed tomography (CT) imaging systems, an x-ray source emits a fan or cone-shaped beam toward a subject or object, such as a patient or a piece of luggage. Hereinafter, the terms “subject” and “object” shall include anything capable of being imaged. The beam, after being attenuated by the subject, impinges upon an array of radiation detectors. The intensity of the attenuated beam radiation received at the detector array is typically dependent upon the attenuation of the x-ray beam by the subject. Each detector element of the detector array produces a separate electrical signal indicative of the attenuated beam received by each detector element. The electrical signals are transmitted to a data processing system for analysis which ultimately produces an image.

Generally, the x-ray source and the detector array are rotated about the gantry within an imaging plane and around the subject. X-ray sources typically include x-ray tubes, which emit the x-ray beam at a focal point. X-ray detectors typically include a collimator for collimating x-ray beams received at the detector, a scintillator for converting x-rays to light energy adjacent the collimator, and photodiodes for receiving the light energy from the adjacent scintillator and producing electrical signals therefrom. Typically, each scintillator of a scintillator array converts x-rays to light energy. Each scintillator discharges light energy to a photodiode adjacent thereto. Each photodiode detects the light energy and generates a corresponding electrical signal. The outputs of the photodiodes are transmitted to the data processing system for image reconstruction. Imaging data may be obtained using x-rays that are generated at a single polychromatic energy. However, some systems may obtain multi-energy images that provide additional information for generating images.

CT system capabilities have increased significantly in recent years. Power of the x-ray tube has increased (average and peak power), detector coverage has increased, and the voltage capability of the generator has increased, as examples. These increases have resulted generally in larger components such as a larger x-ray tube, a larger detector, a larger generator, and a larger heat exchanger, as examples. Thus, in recent years the amount of mass mounted on the gantry has increased substantially with increased power and coverage. To accommodate the increase in mass, the structure itself has been strengthened to maintain component deflections at acceptably low levels.

In addition the speed of the gantry has increased to provide improved temporal resolution in the acquired imaging data and resultant reconstructed images. As is known, in general in a rotational environment G-loading increases as a function of rotational velocity squared. Earlier legacy CT systems had a rotational speed of 1 s/revolution, while more recent systems are on the order of 0.4−0.35 s/revolution. Further, it is desired to increase the rotational speed. As such and overall, all of these trends toward larger components, faster gantry speed, and increased mass of the support structure have led to an increased overall mass of the gantry and its components.

Early CT systems having, for example, 1, 2, or 4 slices have an overall system weight (gantry and the components mounted thereon) less than approximately 1600 kg (3500 lbs). Thus, for these earlier systems, the system is generally fabricated in a manufacturing facility as a single unit and shipped to the site (which can be anywhere across the globe) for installation. However, as system coverage and gantry speed have increased, so too has the overall gantry mass as well. That is, for premium CT systems, gantry designs well in excess of 1600 kg (3500 lbs) are experienced. A commonly experienced gantry weight is 2000 kg (4500 lbs) for a premium CT system and in one example gantry weight of 2700 kg (6000 lbs) occurs.

However, service elevators within hospitals and other facilities typically cannot accommodate weights in excess of, for example, 1600 kg (3500 lbs). As such, when state-of-the-art CT systems are installed in hospital suites, if the system weight exceeds that of the maximum capacity of the service elevator (as is often the case), then the CT system is installed using a system other than the service elevator.

For instance, overweight (e.g., higher than elevator rated weight capability) gantries are typically lifted outside of the customer building with a crane to the higher floor on which they are to be installed, and passed into the building via the crane through a makeshift door. The makeshift door is typically a removed window that is large enough to pass the gantry. However, if such a large window is not available then a much larger project is undertaken to move the system into the facility.

In fact, given the amount of mass in such fully assembled CT systems, it is inconvenient as well, not only from the perspective of transportation into a hospital suite, to fabricate and transport such a massive structure of greater than 1600 kg (3500 lbs).

Therefore, it would be desirable to have a method and apparatus to improve fabrication, transportation, and assembly of a CT system into a building.

### BRIEF DESCRIPTION

Embodiments are directed toward a method and apparatus to improve fabrication, transportation, and assembly of a gantry for a CT system.

According to one aspect, a split gantry for a CT system includes a rotatable side comprising a configurable arrangement of image chain components of the CT system, a stationary side comprising a stationary support base and a gantry bearing, wherein the rotatable side is separate from the stationary side, and the stationary side is attachable to a rotatable portion of the gantry bearing without having to align the image chain components during an installation of the CT system.

According to another aspect, a method of assembling a gantry for a CT system includes obtaining a rotatable side of a gantry from a first container at a site for a CT system installation, wherein the rotatable side includes configurable image chain components of the CT system, obtaining a stationary side of the gantry from a second container, different from the first container, at the site of the CT system installation, wherein the stationary side includes a stationary support base and a gantry bearing, and coupling the rotatable side to the stationary side without having to align the image chain components to each other at the site of the CT system installation.

According to yet another aspect, a method of fabricating a split gantry for a CT system includes assembling a rotatable side of the split gantry that is comprised of image chain components of the CT system, assembling a stationary side of the split gantry that is comprised of a stationary support base and a gantry bearing, wherein the rotatable side is assembled separately from the stationary side, and the stationary side is attachable to a rotatable portion of the gantry bearing without having to align the image chain components during an installation of the CT system.

Various other features and advantages will be made apparent from the following detailed description and the drawings.

### BRIEF DESCRIPTION OF THE DRAWINGS

FIG. 1 is a pictorial view of a CT imaging system that incorporates disclosed embodiments.

FIG. 2 is a block schematic diagram of the system illustrated in FIG. 1.

FIG. 3 illustrates a split gantry for a CT system having a rotatable side and a stationary side.

FIG. 4 illustrates a rotatable side of a split gantry having image chain components in their general orientation about a rotatable base of rotatable side.

FIG. 5 illustrates image chain components in their installed position on rotatable base.

FIG. 6 illustrates a stationary side of the split gantry in its transportation dolly.

FIG. 7 illustrates a transportation dolly for a rotatable side of the split gantry.

FIG. 8 is a pictorial view of a CT system for use with a non-invasive package inspection system according to a disclosed embodiment.

### DETAILED DESCRIPTION

The operating environment of disclosed embodiments is described with respect to a sixty-four-slice computed tomography (CT) system. However, it will be appreciated by those skilled in the art that disclosed embodiments are equally applicable for use with other multi-slice configurations. Moreover, disclosed embodiments will be described with respect to the detection and conversion of x-rays. However, one skilled in the art will further appreciate that embodiments are equally applicable for the detection and conversion of other high frequency electromagnetic energy. Disclosed embodiments will be described with respect to a “third generation” CT scanner, but is equally applicable with other CT systems as well as vascular and surgical C-arm systems and other x-ray tomography systems.

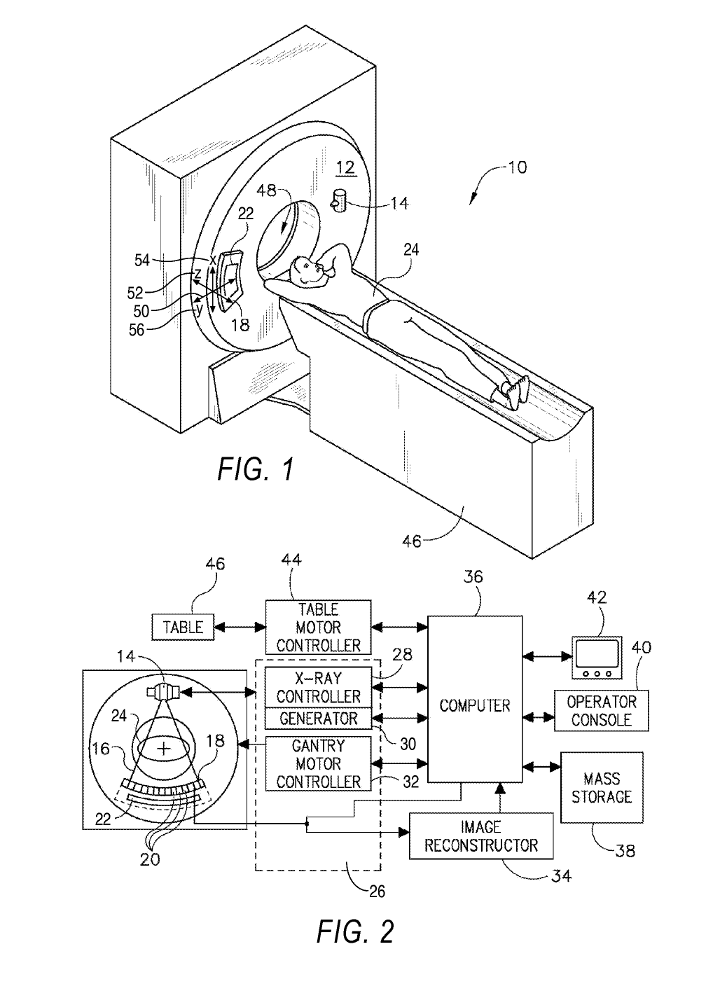

Referring to FIGS. 1 and 2, a computed tomography (CT) imaging system 10 is shown as including a gantry 12 representative of a “third generation” CT scanner. Gantry 12 has an x-ray source 14 that projects a beam of x-rays 16 toward a detector assembly or collimator 18 on the opposite side of the gantry 12. X-ray source 14 includes either a stationary target or a rotating target. Detector assembly 18 is formed by a plurality of detectors 20 and data acquisition systems (DAS) 22. The plurality of detectors 20 sense the projected x-rays that pass through a medical patient 24, and DAS 22 converts the data to digital signals for subsequent processing. Each detector 20 produces an analog electrical signal that represents the intensity of an impinging x-ray beam and hence the attenuated beam as it passes through patient 24. During a scan to acquire x-ray projection data, gantry 12 and the components mounted thereon rotate about a center of rotation.

Rotation of gantry 12 and the operation of x-ray source 14 are governed by a control mechanism 26 of CT system 10. Control mechanism 26 includes an x-ray controller 28 and generator 30 that provides power and timing signals to x-ray source 14 and a gantry motor controller 32 that controls the rotational speed and position of gantry 12. An image reconstructor 34 receives sampled and digitized x-ray data from DAS 22 and performs high speed image reconstruction. The reconstructed image is applied as an input to a computer 36 which stores the image in a mass storage device 38.

Computer 36 also receives commands and scanning parameters from an operator via an operator console 40 that has some form of operator interface, such as a keyboard, mouse, voice activated controller, or any other suitable input apparatus. An associated display 42 allows the operator to observe the reconstructed image and other data from computer 36. The operator supplied commands and parameters are used by computer 36 to provide control signals and information to DAS 22, x-ray controller 28, and gantry motor controller 32. In addition, computer 36 operates a table motor controller 44 which controls a motorized table 46 to position patient 24 and gantry 12. Particularly, table 46 moves patients 24 through a gantry opening 48 in whole or in part. A coordinate system 50 for detector assembly 18 defines a patient or Z-axis 52 along which patient 24 is moved in and out of opening 48, a gantry circumferential or X-axis 54 along which detector assembly 18 passes, and a Y-axis 56 that passes along a direction from a focal spot of X-ray source 14 to detector assembly 18.

X-ray source 14, in accordance with present embodiments, is configured to emit x-rays or x-ray beam 16 at one or more energies. For example, x-ray source 14 may be configured to switch between relatively low energy polychromatic emission spectra (e.g., at approximately 80 kVp) and relatively high energy polychromatic emission spectra (e.g., at approximately 140 kVp). As will be appreciated, x-ray source 14 may also be operated so as to emit x-rays at more than two different energies. Similarly, x-ray source 14 may emit at polychromatic spectra localized around energy levels (i.e., kVp ranges) other than those listed herein (e.g., 100 kVP, 120 kVP, etc.). Selection of the respective energy levels for emission may be based, at least in part, on the anatomy being imaged.

In some embodiments X-ray controller 28 may be configured to selectively activate x-ray source 14 such that tubes or emitters at different locations within system 10 may be operated in synchrony with one another or independent of one another. In certain embodiments discussed herein, the x-ray controller 28 may be configured to provide fast-kVp switching of x-ray source 14 so as to rapidly switch source 14 to emit X-rays at the respective polychromatic energy spectra in succession during an image acquisition session. For example, in a dual-energy imaging context, x-ray controller 28 may operate x-ray source 14 so that x-ray source 14 alternately emits x-rays at the two polychromatic energy spectra of interest, such that adjacent projections are acquired at different energies (i.e., a first projection is acquired at high energy, the second projection is acquired at low energy, the third projection is acquired at high energy, and so forth). In one such implementation, fast-kVp switching operation performed by x-ray controller 28 yields temporally registered projection data. In some embodiments, other modes of data acquisition and processing may be utilized. For example, a low pitch helical mode, rotate-rotate axial mode, N×M mode (e.g., N low-kVp views and M high-kVP views) may be utilized to acquire dual-energy datasets.

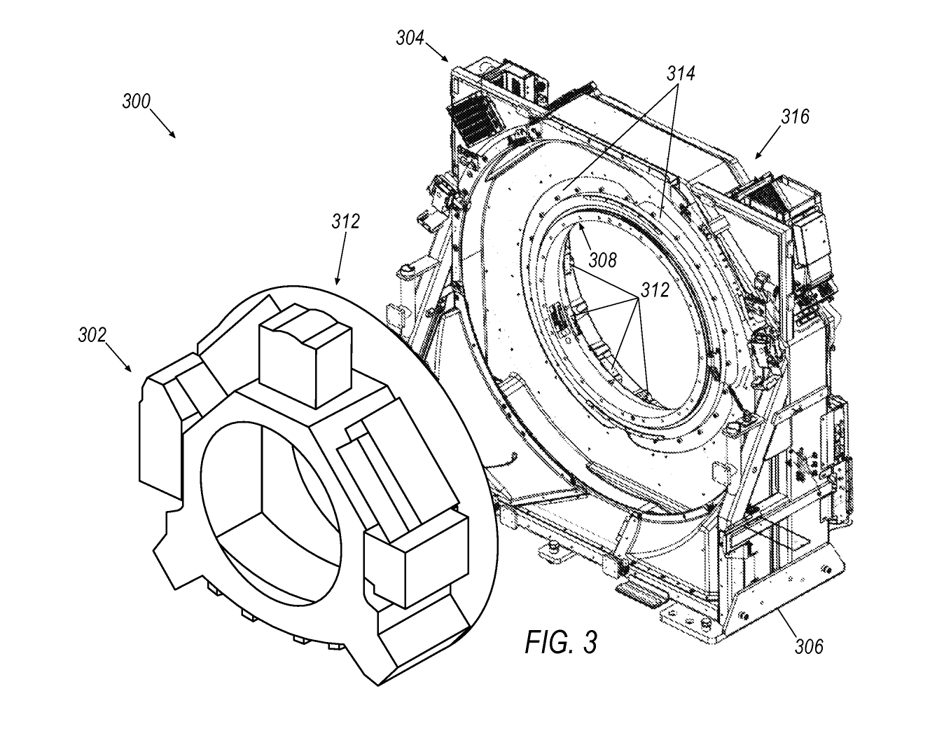

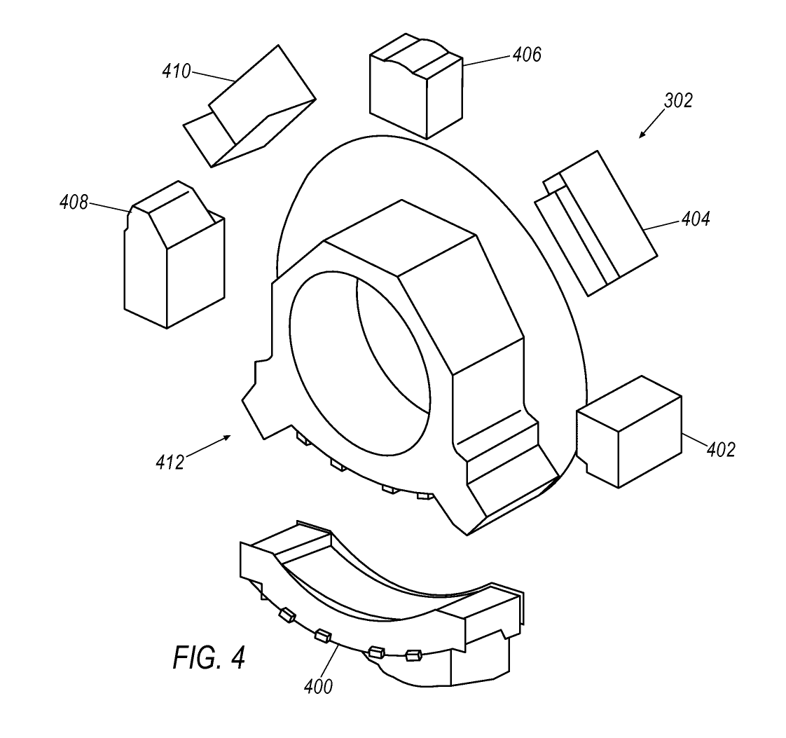

FIG. 3 illustrates a split gantry 300 for a CT system. The system includes a rotatable side 302 including a configurable arrangement of image chain components of the CT system, and a stationary side 304 that includes a stationary support base 306 and a gantry bearing 308. As illustrated therein, the rotatable side 302 is separate from the stationary side 304. The stationary side 304 is attachable to a rotatable portion of gantry bearing 308 without having to align the image chain components during an installation of the CT system.

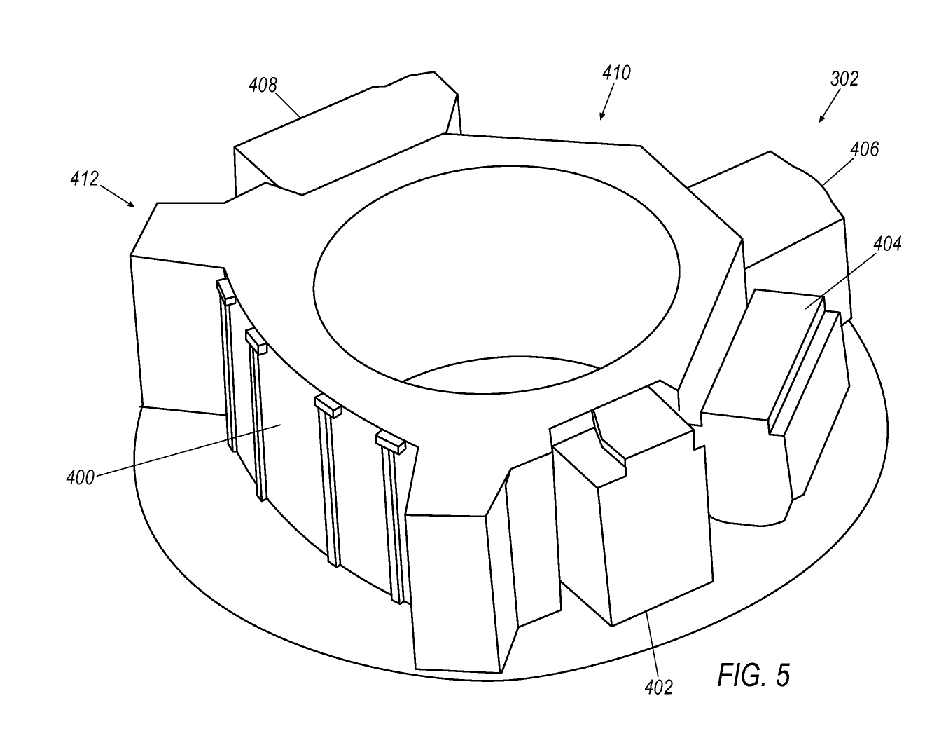

That is, referring to FIG. 4, rotatable side 302 includes image chain components that include but are not limited to a detector or detector assembly, a high voltage tank, an x-ray source, a detector, a heat exchanger, etc. . . . as commonly known and generally represented as image chain components 400-408 that add significant mass to the overall assembly. FIG. 4 shows image chain components 400-408 in their general orientation about a rotatable base 412 of rotatable side 302 and prior to their assembly onto rotatable base 412. Referring to FIG. 5, image chain components 400-408 are shown in their installed position on rotatable base 412, forming rotatable side 302.

Thus, referring back to FIG. 3, split gantry 300 is assembled using a method that includes assembling the rotatable side 302 of the split gantry that includes image chain components 400-408 of the CT system, and the method includes separately assembling a stationary side 304 of split gantry 300 that is comprised of stationary support base 306 and gantry bearing 308. Image chain components 400-408 are assembled onto rotatable base 412 to form rotatable side 302, and rotatable side 302 is assembled separately from stationary side 304. Stationary side 304 is thereby attachable to rotatable portion of gantry bearing 308 without having to align the image chain components during an installation of the CT system.

Stationary side 304 includes slip rings 312 for communicating data and for transmitting power between the rotatable portion of the gantry and a stationary portion of the stationary side. Slip ring 312 is an electromechanical device that allows the transmission of power and electrical signals from stationary side 304 to rotatable side 302. In general, a slip ring can be used in any electromechanical system that requires unrestrained, intermittent or continuous rotation while transmitting power and/or data. It can improve mechanical performance, simplify system operation and eliminate damage-prone wires dangling from movable joints. Thus, in the illustrated application, slip ring 312 is positioned and configured to transmit power and data from across a rotating-stationary interface.

Accordingly, system fabrication, testing, shipping, and assembly are simplified because each side 302, 304 can be fabricated separate from the other. The image chain components 400-408 are positionable relative to one another so that their relative position is properly set in the factory on rotatable side 302 for image data acquisition. Fabrication is thereby simplified because relatively smaller sub-assemblies are assembled independent of one another. In fact, neither side 302, 304 needs to be specifically fabricated for the other, which simplifies shipping logistics, assembly instructions, and the like. In other words, each side 302, 304 is assembled as generic units with respect to each other, and logistical issues are simplified because assemblies of each side 302, 304 can be assembled and tested as generic units. Stationary side 304 and rotatable side 302 of the CT system are configured to be mated together vertically and in their end-use orientation during an installation at a site, and after shipping to the site in separate shipping containers. In addition, because the rotable assembly 302 is not attached to rotatable side 304 during shipment, gantry bearing 308 is thereby not loaded during shipment, reducing or eliminating the likelihood of sustaining vibrational or impact damage.

A sum weight of stationary side 304 and rotatable side 302 exceeds 1600 kg (3500 lbs), however each side 302, 304 on its own does not exceed 1600 kg (3500 lbs). Accordingly, because of the modular design and the fact that sides 302, 304 may be fabricated separately from one another, logistics are further simplified. Not only can sides 302, 304 be shipped for onsite fabrication independent of one another, but the total shipping weight of each does not exceed the typical weight limits of service elevators in most hospitals. Further, it is contemplated that the benefits of the current disclosure can be accrued to systems whose overall weight does not exceed 1600 kg (3500 lbs). That is, although it may be desirable to assemble and ship sides 302, 304 in the fashion described to reduce weight that is moved on-site in an elevator, systems having less than 1600 kg (3500 lbs) total weight can also benefit from the modular design as disclosed and the disclosure herein is thereby applicable to any system, regardless of total weight.

Further, the modular design enables relatively simple installation in the field (e.g., at a CT site) because stationary side 304 is attachable to rotatable side 302 via a plurality of bolts 314 that are accessible from a back side 316 (so that rotatable assembly or side 302 can be attached without impacting image chain components 400-408), as shown in FIG. 3, during gantry assembly. That is, after shipping to the site for the installation, and after removal of sides 302, 304 from any shipping containers or dollies, image chain components 400-408 need not be removed from rotatable side 302, thus simplifying the installation process.

As such, rotatable sides 302, 304 of CT system 10 can be assembled on site and after shipping in separate containers by obtaining rotatable side 302 of split gantry 300 from a first container at a site for a CT system installation. Rotatable side 302 includes configurable image chain components 400-408 of the CT system. Sides 302, 304 are also assembled by obtaining stationary side 304 of split gantry 300 from a second container, different from the first container, at the site of the CT system installation. Stationary side 304 includes stationary support base 306 and gantry bearing 308. Rotatable side 302 is coupled to stationary side 304 without having to align the image chain components 400-408 to each other at the site of the CT system installation.

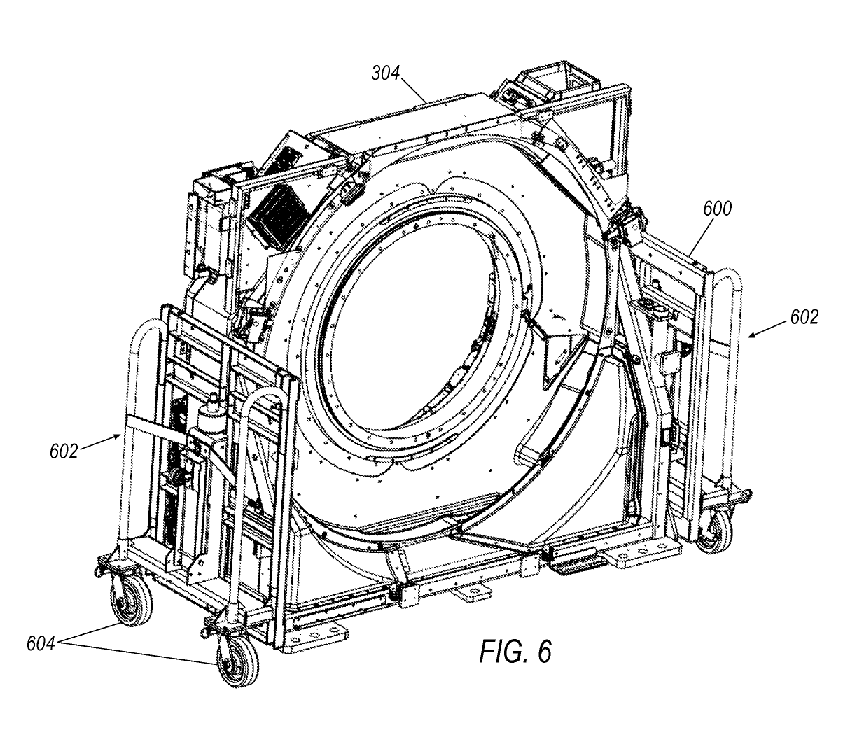

Referring to FIG. 6, a stationary side dolly 600 is shown in which stationary side 304 is positioned for assembly, shipping, and installation. Stationary side dolly 600 is configured to transport stationary side 304 to the site for the installation in a shipping box (box not shown), and includes interface features for transportation and assembly, to include but not limited to side supports 602 for clamping to stationary side 304, wheels 604, and the like. In such fashion, dolly 600 is used for assembly of stationary side 304 at a manufacturing side, and dolly 600 provides mobility during the process. Dolly 600 stays with stationary side 304 after assembly, and is fit into a box (not shown) for shipping to the site. On site, dolly 600 conveniently is used to wheel from any delivery vehicle to a service elevator, and to the final site for system assembly. The box may be configured such that component parts are protected from weather (wind, rain, etc.) but may be used during the transportation stage from the manufacturing site to the final location for installation.

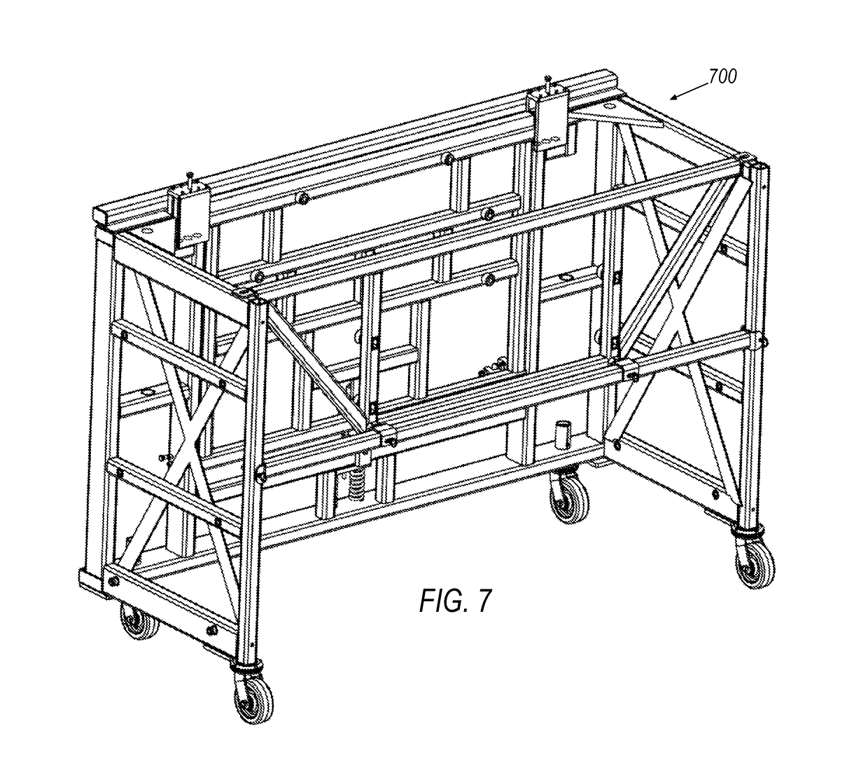

Referring to FIG. 7, a rotatable side dolly 700 is illustrated that can be used for fabrication, shipping, and assembly. Dolly 700 includes support features 702 for clamping to rotatable side 302, wheels 704, and the like. In such fashion, dolly 700 is used for assembly of rotatable side 302 at a manufacturing site, and dolly 700 provides mobility during the process. Dolly 700 stays with rotatable side 302 after assembly, and is fit into a box (not shown) for shipping to the site. On site, dolly 700 conveniently is used to wheel from any delivery vehicle to a service elevator, and to the final site for system assembly. The box may be configured such that component parts are protected from weather (wind, rain, etc.) but may be used during the transportation stage from the manufacturing site to the final location for installation.

Thus, sides 302, 304 are shipped in separate dollies that are fabricated for simplification of manufacturing, shipping, handling during shipping, transportation at the assembly site, and during assembly. Although referred to as dollies 600, 700, such may be referred to more generally as shipping containers that may include the functionality as described for each dolly 600, 700, but may also include a box or other protection that is not shown in FIGS. 6 and 7.

As such, a disclosed method of assembly includes capturing rotatable side 302 of the split gantry 300 in a transportation dolly 700, and capturing stationary side 304 of split gantry 300 in transportation dolly 600. The parts are shipped for CT system installation on their respective dollies.

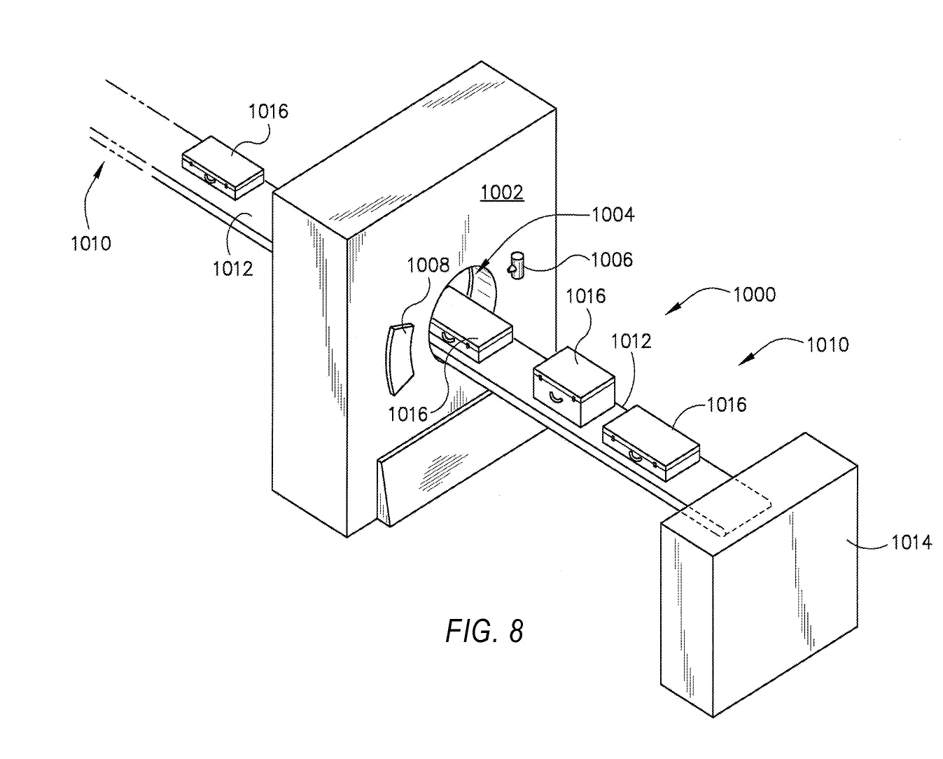

Referring now to FIG. 8, there is shown a package/baggage inspection system 1000 that can use the image acquisition and reconstructions techniques according to embodiments disclosed and which includes a rotatable gantry 1002 having an opening 1004 therein through which packages or pieces of baggage may pass. The rotatable gantry 1002 houses one or more x-ray energy sources 1006 as well as a detector assembly 1008 having scintillator arrays comprised of scintillator cells. A conveyor system 1010 is also provided and includes a conveyor belt 1012 supported by structure 1014 to automatically and continuously pass packages or baggage pieces 1016 through opening 1004 to be scanned. Objects 1016 are passed through opening 1004 by conveyor belt 1012, imaging data is then acquired, and the conveyor belt 1012 removes the packages 1016 from opening 1004 in a controlled and continuous manner. As a result, postal inspectors, baggage handlers, and other security personnel may non-invasively inspect the contents of packages 1016 for explosives, knives, guns, contraband, etc.

An implementation of system 10 and/or 1000 in an example comprises a plurality of components such as one or more of electronic components, hardware components, and/or computer software components. A number of such components can be combined or divided in an implementation of the system 10 and/or 1000. An exemplary component of an implementation of the system 10 and/or 1000 employs and/or comprises a set and/or series of computer instructions written in or implemented with any of a number of programming languages, as will be appreciated by those skilled in the art. An implementation of system 10 and/or 1000 in an example comprises any (e.g., horizontal, oblique, or vertical) orientation, with the description and figures herein illustrating an exemplary orientation of an implementation of the system 10 and/or 1000, for explanatory purposes.

According to one embodiment, split gantry for a CT system includes a rotatable side comprising a configurable arrangement of image chain components of the CT system, a stationary side comprising a stationary support base and a gantry bearing, wherein the rotatable side is separate from the stationary side, and the stationary side is attachable to a rotatable portion of the gantry bearing without having to align the image chain components during an installation of the CT system.

According to another embodiment, a method of assembling a gantry for a CT system includes obtaining a rotatable side of a gantry from a first container at a site for a CT system installation, wherein the rotatable side includes configurable image chain components of the CT system, obtaining a stationary side of the gantry from a second container, different from the first container, at the site of the CT system installation, wherein the stationary side includes a stationary support base and a gantry bearing, and coupling the rotatable side to the stationary side without having to align the image chain components to each other at the site of the CT system installation.

According to yet another embodiment, a method of fabricating a split gantry for a CT system includes assembling a rotatable side of the split gantry that is comprised of image chain components of the CT system, assembling a stationary side of the split gantry that is comprised of a stationary support base and a gantry bearing, wherein the rotatable side is assembled separately from the stationary side, and the stationary side is attachable to a rotatable portion of the gantry bearing without having to align the image chain components during an installation of the CT system.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the preceding discussion is generally provided in the context of medical imaging, it should be appreciated that the present techniques are not limited to such medical contexts. The provision of examples and explanations in such a medical context is to facilitate explanation by providing instances of implementations and applications. The disclosed approaches may also be utilized in other contexts, such as the non-destructive inspection of manufactured parts or goods (i.e., quality control or quality review applications), and/or the non-invasive inspection of packages, boxes, luggage, and so forth (i.e., security or screening applications).

While that disclosed has been described in detail in connection with only a limited number of embodiments, it should be readily understood that disclosed embodiments are not limited to such disclosed embodiments. Rather, that disclosed can be modified to incorporate any number of variations, alterations, substitutions or equivalent arrangements not heretofore described, but which are commensurate with the spirit and scope of the disclosure. Furthermore, while single energy and dual-energy techniques are discussed above, that disclosed encompasses approaches with more than two energies. Additionally, while various embodiments have been described, it is to be understood that disclosed aspects may include only some of the described embodiments. Accordingly, that disclosed is not to be seen as limited by the foregoing description, but is only limited by the scope of the appended claims.

What is claimed is:

1. A split gantry for a CT system, comprising:
a rotatable side comprising a configurable arrangement of image chain components of the CT system;
a stationary side comprising a stationary support base and a gantry bearing, wherein:
the rotatable side is separate from the stationary side; and
the stationary side is attachable to a rotatable portion of the gantry bearing without having to align the image chain components during an installation of the CT system.

2. The gantry of claim 1, wherein the stationary side includes a slip ring for communicating data and for transmitting power between the rotatable portion of the gantry and a stationary portion of the stationary side.

3. The gantry of claim 1, wherein a sum weight of the stationary side and the rotatable side exceeds 1600 kg (3500 lbs).

4. The gantry of claim 1, wherein the image chain components include at least a detector, a high voltage tank, an x-ray source, and a heat exchanger.

5. The gantry of claim 1, wherein the stationary side is attachable to the rotatable side via a plurality of bolts that are accessible during gantry assembly and without having to remove any of the image chain components from the rotatable side after shipping to the site for the installation.

6. The gantry of claim 1, wherein the stationary side and the rotatable side are configured to be mated together in their end-use orientation during an installation at a site and after shipping to the site in separate shipping containers.

7. The gantry of claim 6, wherein the stationary side and the rotatable side include interface features for transportation and assembly dollies, wherein:
a first of the dollies is configured to transport the stationary side to the site for the installation; and
a second of the dollies is configured to transport the rotatable side to the site for the installation.

8. A method of assembling a gantry for a CT system, comprising:
obtaining a rotatable side of a gantry from a first container at a site for a CT system installation, wherein the rotatable side includes configurable image chain components of the CT system;
obtaining a stationary side of the gantry from a second container, different from the first container, at the site of the CT system installation, wherein the stationary side includes a stationary support base and a gantry bearing; and
coupling the rotatable side to the stationary side without having to align the image chain components to each other at the site of the CT system installation.

9. The method of claim 8, wherein the stationary side includes a slip ring for communicating data and for transmitting power between the rotatable portion of the gantry and a stationary portion of the stationary side.

10. The method of claim 8, wherein a weight of each of the stationary side and the rotatable side is less than 1600 kg (3500 lbs).

11. The method of claim 8, wherein the image chain components include at least a detector, a high voltage tank, an x-ray source, and a heat exchanger.

12. The method of claim 8, wherein the step of coupling the rotatable side to the stationary side comprises bolting the rotatable side to the stationary side with a plurality of bolts that are accessible during gantry assembly and without having to remove any of the image chain components from the rotatable side after obtaining the rotatable side from the first container.

13. The method of claim 8, wherein the step of coupling the rotatable side to the stationary side comprises mating the rotatable side to the stationary side vertically and in their end-use orientation during the CT system installation.

14. The method of claim 8, further comprising:
capturing the rotatable side of the gantry in a first transportation dolly;
capturing the stationary side of the gantry in a second transportation dolly;
shipping the rotatable side to the site for the CT system installation in the first transportation dolly; and
shipping the stationary side of the gantry to the site for the CT system installation in the second transportation dolly.

15. A method of fabricating a split gantry for a CT system, comprising:
assembling a rotatable side of the split gantry that is comprised of image chain components of the CT system;
assembling a stationary side of the split gantry that is comprised of a stationary support base and a gantry bearing, wherein:
the rotatable side is assembled separately from the stationary side; and
the stationary side is attachable to a rotatable portion of the gantry bearing without having to align the image chain components during an installation of the CT system.

16. The method of claim 15, wherein the stationary side includes a slip ring for communicating data and for transmitting power between the rotatable portion of the gantry and a stationary portion of the stationary side.

17. The method of claim 15, wherein a weight of each of the stationary side and the rotatable side is less than 1600 kg (3500 lbs).

18. The method of claim 15, wherein the image chain components include at least a detector, a high voltage tank, an x-ray source, and a heat exchanger.

19. The method of claim 15, wherein the stationary side is attachable to the rotatable side with the step of bolting the rotatable side to the stationary side with a plurality of bolts that are accessible during gantry assembly and without having to remove any of the image chain components from the rotatable side after obtaining the rotatable side from its shipping container.

20. The method of claim 15, wherein the stationary side is attachable to the rotatable side with the step of mating the rotatable side to the stationary side in their end-use orientation during the installation.
